(19) United States
(12) Patent Application Publication
(10) Pub. No.: US 2009/0178143 A1
(43) Pub. Date: Jul. 9, 2009

(54) Method and System for Embedding Information in Computer Data

(75) Inventors: Kamyar F. Shadan, Tiburon, CA (US); Paul Bertucci, Eugene, OR (US)

Correspondence Address: WILSON SONSINI GOODRICH & ROSATI, 650 PAGE MILL ROAD, PALO ALTO, CA, 94304-1050, US

(73) Assignee: DIGINOME, INC., Novato, CA (US)

(21) Appl. No.: 12/042,272

(22) Filed: Mar. 4, 2008

Related U.S. Application Data
(60) Provisional application No. 61/019,558, filed on Jan. 7, 2008.

(51) Int. Cl. G06F 21/00

(52) U.S. Cl. 726/26

(57) ABSTRACT

Provided is a system for embedding traits in data wherein the data is stored within one or more data storage system(s), comprising: a code generator, the code generator generating a code describing the traits of the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; wherein the data storage systems are selected from the group consisting of: Microsoft SQL servers, IBM DB2 servers, Oracle servers, and Sybase servers.

### CROSS-REFERENCE

This application claims the benefit of U.S. Provisional Application No. 61/019,558, filed Jan. 7, 2008, the contents of which are incorporated herein by reference in their entirety.

### FIELD OF THE INVENTION

The present invention relates generally to a method and system for embedding information into data, more specifically for embedding information concerning the origin of the data.

### BACKGROUND OF THE INVENTION

Traditionally, digits have been used to identify specified quantities. They have been used to represent capital expenditures, revenues, phone numbers, social security numbers, distance, weight, age, etc. Standing alone, digits have no distinguishing character and are considered random, assignable and auxiliary tools.

Assigned digits are manmade and identify critical information in various contexts. There are numerous prior art methods for using digits in other areas such as encryption and programming. This random use of digits is an anonymous device to identify something else. The digits themselves have no inherent meaning or definition.

Using digital signatures for validating data is well known. However, such signatures are not valid indefinitely, but only during the validity periods of their authentication certificates. This presents a problem for numerical digits, which reside in financial documents, spreadsheets, reports, etc., and are stored on hard drives of computers, floppy discs, and other data storage means.

### SUMMARY OF THE INVENTION

In some embodiments, the invention comprises a system for embedding traits in data wherein the data is stored within one or more data storage system(s), comprising: a code generator, the code generator generating a code describing the traits of the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; and wherein the data storage systems are selected from the group consisting of: Microsoft SQL servers, IBM DB2 servers, Oracle servers, and Sybase servers.

In some embodiments, the traits of the data are selected from the group consisting of: the time when the data was created, modified, or deleted; who created, modified, or deleted the data; when a copy of the data was made; who made a copy of the data; and security and access information.

In some embodiments, a decoder is coupled to the storage unit, the decoder decoding the encoded data to reveal the traits of the data.

In some embodiments, the code is tamper detectable.

In some embodiments, the data is a computer generated numerical digit.

In some embodiments, the data is an alphanumeric string.

In some embodiments, the traits are encoded in the bit plane of the data.

In some embodiments, the certificate value is also encoded in the bit plane of the data.

In some embodiments, the invention comprises a data storage system having an executable program stored thereon, the program comprising the steps of: in response to the generation of data, assigning traits to the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; and wherein the data storage systems are selected from the group consisting of: Microsoft SQL servers, IBM DB2 servers, Oracle servers, and Sybase servers.

In some embodiments, the traits of the data are selected from the group consisting of: the time when the data was created, modified, or deleted; who created, modified, or deleted the data; when a copy of the data was made; who made a copy of the data; and security and access information.

In some embodiments, the program further comprises the step of decoding the data to reveal the traits assigned to the data.

In some embodiments, the step of encoding the data in the program includes embedding the code in a bit plane of the data.

In some embodiments, the step of encoding the data in the program includes making the data tamper detectable.

In some embodiments, the certificate value is encoded in the bit plane of the data.

In some embodiments, the invention comprises a method for creating a history of data stored within one or more data storage systems comprising: a code generator, the code generator generating a code describing the traits of the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; and wherein the data storage systems are selected from the group consisting of: Microsoft SQL servers, IBM DB2 servers, Oracle servers, and Sybase servers.

In some embodiments, the traits of the data are selected from the group consisting of: the time when the data was created, modified, or deleted; who created, modified, or deleted the data; when a copy of the data was made; who made a copy of the data; and security and access information.

In some embodiments, the encoded data is decoded to retrieve the traits assigned to the data.

In some embodiments, the encoded data is tamper detectable.

In some embodiments, the traits are encoded in a bit plane of the data.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

FIGS. 1-10 illustrate embodiments of the invention. In particular:

FIG. 1 is a block diagram illustrating a system for data encoding in accordance with the present invention.

### DETAILED DESCRIPTION OF THE INVENTION

Provided herein are methods and systems for creating and recording the history of data, more specifically digits. Methods of use for the representation are also provided.

In some embodiments, the invention comprises a system for embedding traits in data wherein the data is stored within one or more data storage system(s), comprising: a code generator, the code generator generating a code describing the traits of the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; and wherein the data storage systems are selected from the group consisting of: Microsoft SQL servers, IBM DB2 servers, Oracle servers, and Sybase servers.

In some embodiments, the traits of the data are selected from the group consisting of: the time when the data was created, modified, or deleted; who created, modified, or deleted the data; when a copy of the data was made; who made a copy of the data; and security and access information.

In some embodiments, a decoder is coupled to the storage unit, the decoder decoding the encoded data to reveal the traits of the data.

In some embodiments, the code is tamper detectable.

In some embodiments, the data is a computer generated numerical digit.

In some embodiments, the data is an alphanumeric string.

In some embodiments, the traits are encoded in the bit plane of the data.

In some embodiments, the certificate value is also encoded in the bit plane of the data.

In some embodiments, the invention comprises a data storage system having an executable program stored thereon, the program comprising the steps of: in response to the generation of data, assigning traits to the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; and wherein the data storage systems are selected from the group consisting of: Microsoft SQL servers, IBM DB2 servers, Oracle servers, and Sybase servers.

In some embodiments, the traits of the data are selected from the group consisting of: the time when the data was created, modified, or deleted; who created, modified, or deleted the data; when a copy of the data was made; who made a copy of the data; and security and access information.

In some embodiments, the program further comprises the step of decoding the data to reveal the traits assigned to the data.

In some embodiments, the step of encoding the data in the program includes embedding the code in a bit plane of the data.

In some embodiments, the step of encoding the data in the program includes making the data tamper detectable.

In some embodiments, the certificate value is encoded in the bit plane of the data.

In some embodiments, the invention comprises a method for creating a history of data stored within one or more data storage systems comprising: a code generator, the code generator generating a code describing the traits of the data; a rules engine, the rules engine classifying the traits into codes; an encoder coupled to the code generator, wherein the encoder encodes the data with the code describing the traits of the data, to generate encoded data; and a storage unit coupled to the encoder, the storage unit storing the encoded data; and wherein the data storage systems are selected from the group consisting of: Microsoft SQL servers, IBM DB2 servers, Oracle servers, and Sybase servers.

In some embodiments, the traits of the data are selected from the group consisting of: the time when the data was created, modified, or deleted; who created, modified, or deleted the data; when a copy of the data was made; who made a copy of the data; and security and access information.

In some embodiments, the encoded data is decoded to retrieve the traits assigned to the data.

In some embodiments, the encoded data is tamper detectable.

In some embodiments, the traits are encoded in a bit plane of the data.

### Definitions

As used herein, storage unit means anything capable of storing computer data. This includes, but is not limited to, a hard drive disk, CD-ROM, magnetic tape, a Magneto Optical Disk, DVD-ROM, DVD-RAM, floppy disks, RAM chips, ROM chips, EPROM, and EEPROM.

### Figures

Further features and advantages of the present invention will become apparent from the following and more particular description of various embodiments of the present invention, as illustrated in the accompanying drawings.

The history data and its contextual characteristics have never been more important to the success of capital markets and the progression of the free world, free markets, and the world economy. Data has been randomly altered, changed, extracted, reported, and transcribed. This invites error, and fraud due to the level of discretion involved. The concept of chain of custody or provenance has never been used with data, only physical objects.

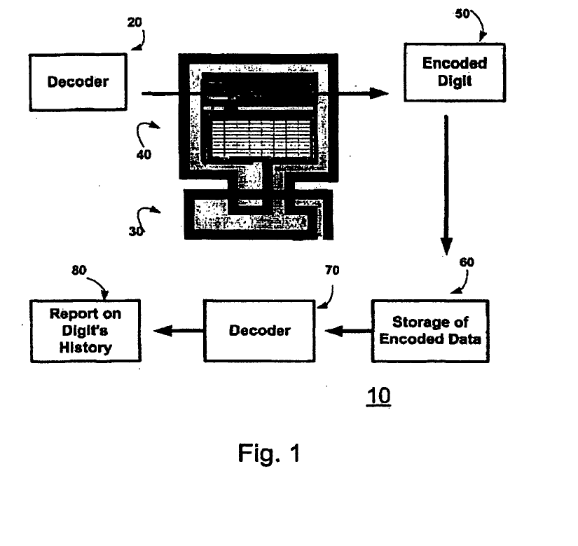

FIG. 1 is a block diagram illustrating a data encoding system, and more specifically a digit encoding system, 10 in accordance with one embodiment of the invention. System 10 comprises an encoder 20 for embedding date information into a digit, e.g., digit “1”, entered via a computer 30 in the first cell of a spreadsheet displayed in a monitor 40. By way of example, computer 30 may be a mainframe computer, a personal computer, a desktop computer, a notebook computer, a mobile computer, a laptop computer, a pocket computer, a workstation computer, and so forth.

A software program in conjunction with an internal real time clock (not shown) of computer 30 sends the generation date of the digit “1” to encoder 20. In accordance with one embodiment of the present invention, the software program is based on a much less complicated program version than data fingerprinting programs that are well known to those of ordinary skill in the art and that are not used in conjunction with a real time clock.

Encoder 20 encrypts and preferably compresses the date information and embeds it or otherwise attaches the date information to that digit and all subsequent digits entered or generated by the software program to form an encoded digit 50 or a data file. Encoded digit 50 or entire data file is then sent to a storage unit 60. In accordance with a preferred embodiment, storage unit 60 is a hard disk drive. However, this is not intended as a limitation on the scope of the present invention. Additional storage mediums suitable for storage unit 60 include Compact Disk-Read Only Memory (CD-ROM), magnetic tape, Magneto Optical Disk (MO), Digital Video Disk-Read Only Memory (DVD-ROM), Digital Video Disk-Random Access Memory (DVD-RAM), floppy disk, memory chips such as Random Access Memory (RAM) chips and Read Only Memory (ROM) chips, Erasable Programmable Read Only Memory (EPROM), and Electrically Erasable Programmable Read Only Memory (EEPROM).

In various embodiments of the present invention, additional traits can be embedded into the data, including a code representing the date the data is modified, and the date the data is sent to the archives or the entire file is deleted from the record media.

The stored data from storage unit 60 may be sent to a decoder 70 to reverse the encryption of the data information and history of the data in the data file. The decrypted information is stored in the form of a history 80. The keys to decode the data or the entire file resides in only those trusted persons in an organization, corporation, database company, government entity and/or any other groups of individuals who rely on the data in databases, reports and other documents, to have a source of authentication along with standard identifiers used in test, spreadsheets or databases.

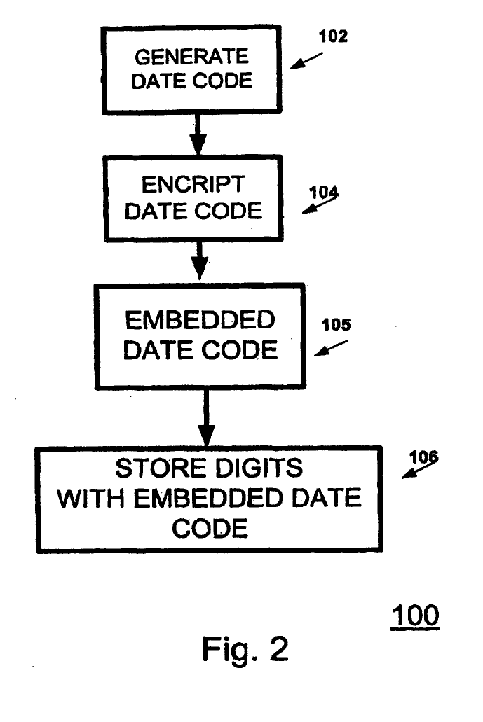

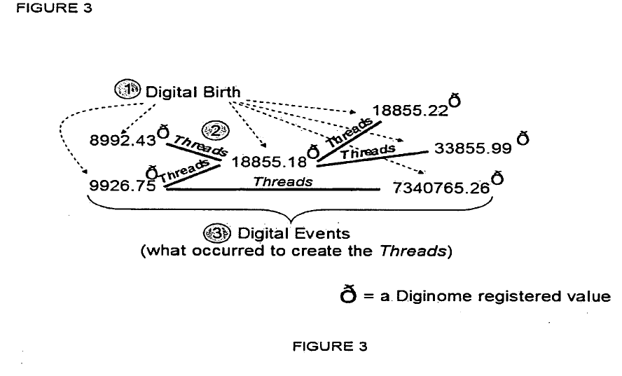

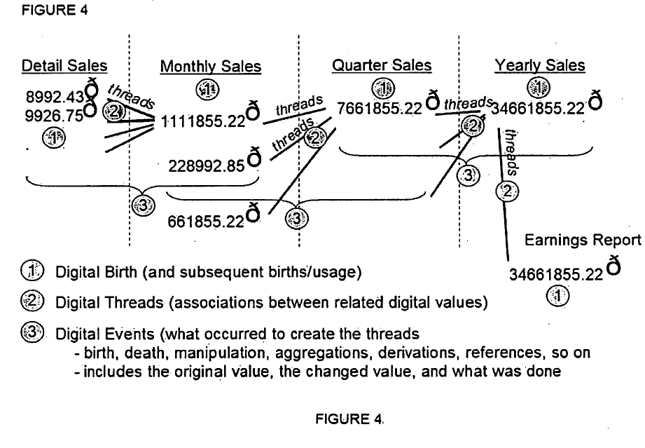

FIG. 2 illustrates a process 100 for embedding data in computer generated digits in accordance with the present invention. By way of example, data embedding process 100 can be performed using system 10 shown in FIG. 1. In a step 102, a date code for each computer generated digit is established based on a computer's real time clock. In a step 104, the date code is encrypted. In accordance with a specific embodiment, step 104 of encrypting the date code also compresses the date code. It should be noted that compressing the date code is optional in accordance with the present invention. A digital block representing this encrypted date code or time code is embedded or otherwise attached to the digital blocks representing each digit, e.g., the digit's bit plane, in a step 105, thereby forming a date stamp or time stamps of the digit. Subsequently in a step 106, the data files containing the plurality of digits with their corresponding embedded date codes are sent to a storage element, e.g., a record medium. The date codes form hidden attributes of the digits making up a data file and will not appear on either a display monitor or a subsequent offset printing of a document representing a spreadsheet or other data file.

The digital stamp in accordance with the present invention includes a scrambled code representing, for example, the digit's date of generation or origin, and history. This feature is not present in digital watermarks that include a number of fields selected from information on a copyrightable work, such as musical recordings, movies, and video games. The digital stamps in accordance with a specific embodiment of the present invention are encoded by conventional encoding means, like those in the digital watermarks. Random or pseudo random keys can serve as the means for locating and decoding the date code information. These secret keys are programmed to be impossible for a party without the key to find the digital stamp and, more importantly, attempt to tamper or otherwise alter the stamp. Secret keys or single key algorithms are all included under the field of key cryptography such as Data Encryption Standard (DES), preferably using Triple-DES algorithm and an Open-Pretty Good Privacy (PGP) format that are well known to those skilled in the art.

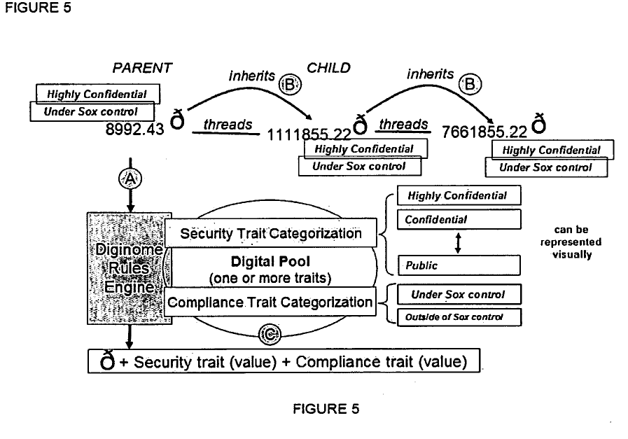

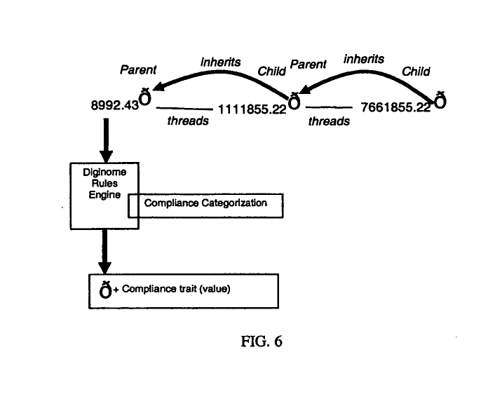

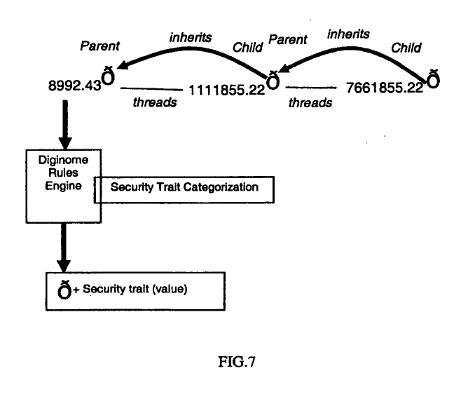

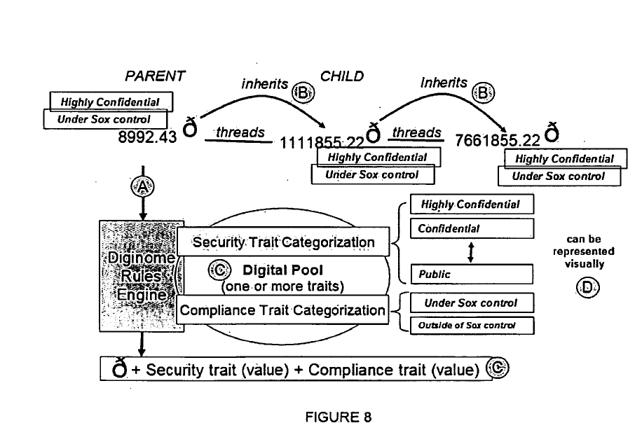

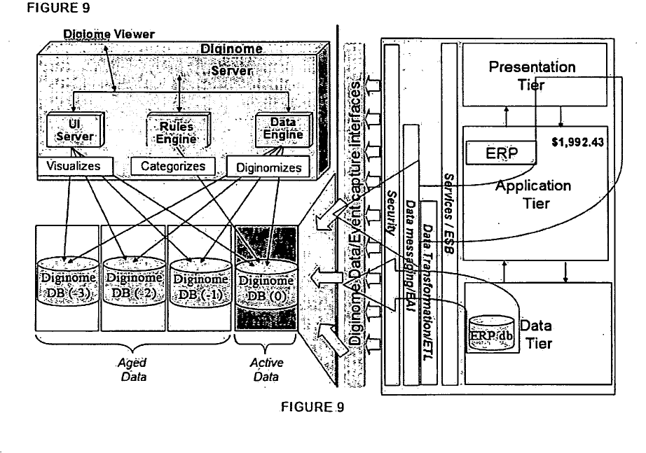

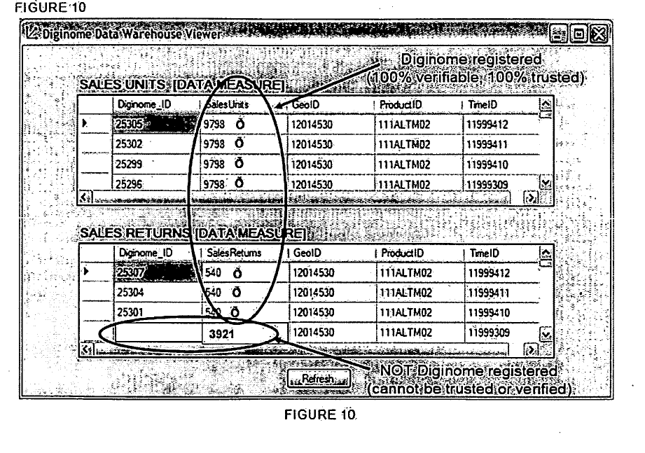

FIG. 5 illustrates an additional component of the invention. Digital categorizations or traits can also be assigned to any data. By way of non-limiting example, a trait might be the level of security or privacy attached to the information, or that the data is under SOX control. This added dimension to the data can allow one to more efficiently identify types of data, and control access to the data for security, compliance, and other reasons. In FIG. 5, the trait is a categorization of the data's sensitivity (from highly confidential to public data sensitivity). It is this evaluated categorization (or “trait”) that will also be recorded with the data value. It is possible that this system of security/access control could replace the traditional metadata-based security/access control.

As with biological heredity, these data traits can be inherited as either dominant or recessive. If the trait is set as dominant, then any “offspring” of the data will also inherit the trait. By way of non-limiting example, the trait can be highly confidential. If the trait is set as dominant, then any offspring of the data would also possess the trait of highly confidential. In FIG. 5, the parent/child thread that represents some digital event between these two data values can carry forward the highly confidential trait from parent to child (from 8992.43 to 1111855.22).

Two or more traits can form a digital “gene pool.” It is possible for these digital gene pools to be represented visually by a marker.

The data embedding method and system in accordance with the present invention has a wide range of applications. The following scenarios represent non-exclusive examples of the applications.

### EXAMPLES

### Revenue Numbers

Revenue numbers are often preceded by additional information, e.g., projected numbers. Once a projection is entered into a financial spreadsheet or any electronic form, it will be given an embedded and encrypted time stamp. Any alterations to the revenue number will be recorded so that the record will contain complete and detailed historical information. Once the actual numbers come in, the history of the digit will show replacement of the projection with actual numbers and that process will continue and provide a detailed profile of with whom that number was shared, who altered it and who attempted to alter it. Any alteration of the digit will require one, two, three, or other specified approvals based on the organizations business rules or the standards to be placed on such intricate and important information.

### Bank Accounts

An account is opened and given an account number based on the business rules of the institution. When the account is created, the initial deposit gives rise to the birth of a unique number with features and characteristics distinct from any other number. That number, which may be “0”, is given a birth time and date along with characteristic information such as the form and source of currency. The information is embedded within the number and encrypted. From that point on the newly born number will have its heritage and ancestry embedded in it until it is moved, transformed, or deleted. Every subsequent transaction, addition or deduction will be recorded in this manner so that the history of any given number within the account, e.g., balance, deposit, withdrawal, etc., will always be available. Upon closing the account, the account number will be archived with a balance, e.g., “0”, and that “0” will contain a historical genome reflecting the events, times, locations and heritage of its existence. As funds flow out of the individual account, the unique digit will become part of another digit heritage and will be able to unravel history, which will go back to that particular digit history along with its heritage.

### Social Security Numbers

An embodiment of the present invention can be applied to Social Security numbers. Once a person is born and given a social security number, an encrypted history file can be embedded that will reflect all major and detectable events in that persons life from beginning to end. Additionally, the social security number can be given the dominant trait of highly confidential. This would limit access to the number and any offspring data associated with it.

### Medical Records

An embodiment of the present invention can be applied to medical records. Once a medical record is established, an embodiment of the invention can be applied to the record such that all traits of the records can be tracked. Thus, any changes to the record (such as updates from new medical exams) will be tracked, as will the identity of the person initiating the change. Additionally, the records can be given the dominant trait of highly confidential. This would limit access to the number and any offspring data associated with it.

### Debt

A person's debt can be tracked from origin to payoff or default. This will help prevent the kiting of bank loans and credit cards along with corporate debt taken on by companies such as leases, and sales lease backs. This number will have a birth date with a complete history of its origin, life and retirement. For corporations, the history will reflect who, when, why and how the liability was created along with the contractual relationship backing it.

### Assets

Asset tracking is critical in our current mode of crisis especially due to very sophisticated money laundering schemes and terrorist initiatives worldwide. The present invention can be used to track assets from birth through all transfers and manipulations that take place within it. A dollar earned by a smuggler or a terrorist is unique and has a unique history that needs to be traceable. So when funds are deposited into an overseas account, according to the present invention, they will have an encrypted, embedded historical record that cannot be erased without a decryption key.

### FDA Approval

An embodiment of the present invention can be applied to the process of drug approval. Once it is established that a drug maker will seek FDA approval for its drug, an embodiment of the invention can be applied to the records of the drug trial such that all traits of the records can be tracked. Thus, any changes to the record (such as updates from new drug trial) will be tracked, as will the identity of the person initiating the change. Additionally, the records can be given the dominant trait of highly confidential. This would limit access to the number and any offspring data associated with it.

By now it should be appreciated that a method and system for creating a permanent and authentic history of data have been provided. The method and system enable one to track the life path of data. In accordance with the present invention, the method comprises embedding data with a tamper detectable date-time stamp including, among other things, the date when the data is generated in the computer; the date of any modifications; what modifications were made; how the modifications were made; who made the modifications; and security or access information. The system includes an encoder for providing the data with the date stamp, a storage unit for storing the encoded numerical data, and a decoder for decoding the data to indicate at least the date of origin of the numerical data.

Without departing from the spirit and scope of this invention, one of ordinary skill in the art can make various changes and modifications to the invention to adapt it to various usages and conditions. For example, the method and system in accordance with the present invention has been illustrated using representative hardware. However, the invention is equally adaptive to the use of hardware that is likely to have widespread use in the future. As such, these changes and similar modifications are properly, equitably, and intended to be, within the full range of equivalents of the following claims.

What is claimed is:

1. A system for embedding traits in data wherein the data is stored within one or more data storage system(s), comprising:
a. a code generator, the code generator generating a code describing the traits of the data;
b. a rules engine, the rules engine classifying the traits into codes;
c. an encoder coupled to the code generator, wherein the encoder encodes the data with the code describing the traits of the data, to generate encoded data; and
d. a storage unit coupled to the encoder, the storage unit storing the encoded data;
wherein the data storage systems are selected from the group consisting of: Microsoft SQL servers, IBM DB2 servers, Oracle servers, and Sybase servers.

2. The system of claim 1, wherein the traits of the data are selected from the group consisting of: the time when the data was created, modified, or deleted; who created, modified, or deleted the data; when a copy of the data was made; who made a copy of the data; security and access information; data privacy; and under SOX compliance.

3. The system of claim 1, wherein a decoder is coupled to the storage unit, the decoder decoding the encoded data to reveal the history and/or traits of the computer generated data.

4. The system of claim 1, wherein the code generator is further configured to generate additional code as additional traits are assigned to the data.

5. The system of claim 1, wherein the code is tamper detectable.

6. The system of claim 1, wherein the data is a digit.

7. The system of claim 1, wherein the data is an alphanumeric string.

8. The system of claim 11, wherein the traits are encoded in the bit plane of the data.

9. The system of claim 1, wherein the certificate value is also encoded in the bit plane of the data.

10. A data storage system having an executable program stored thereon, the program comprising the steps of:
a. the code generator generating a code describing traits of the data;
b. a rules engine, wherein the rules engine the traits into codes;
c. an encoder coupled to the code generator, wherein the encoder encodes the data with the code describing the traits of the data, to generate encoded data; and
d. a storage unit coupled to the encoder, the storage unit storing the encoded data.

11. The data storage system of claim 10, wherein the traits of the data are selected from the group consisting of: the time when the data was created, modified, or deleted; who created, modified, or deleted the data; when a copy of the data was made; who made a copy of the data; security and access information; data privacy; and under SOX compliance.

12. The data storage system of claim 10, wherein the program further comprises the step of decoding the data to reveal the traits of the data.

13. The data storage system of claim 10, wherein the step of encoding the data in the program includes embedding the code in a bit plane of the data.

14. The data storage system of claim 10, wherein the step of encoding the data in the program includes making the code tamper detectable.

15. The data storage system of claim 10, wherein the certificate value is encoded in the bit plane of the data.

16. A method for creating a history of data stored within one or more data storage system(s), comprising:
a. a code generator, the code generator generating a code describing the traits of the data;
b. a rules engine, the rules engine classifying the traits into codes;
c. an encoder coupled to the code generator, wherein the encoder encodes the data with the code describing the traits of the data, to generate encoded data; and
d. a storage unit coupled to the encoder, the storage unit storing the encoded data;
wherein the data storage systems are selected from the group consisting of: Microsoft SQL servers, IBM DB2 servers, Oracle servers, and Sybase servers.

17. The system of claim 16, wherein the traits of the data are selected from the group consisting of: the time when the data was created, modified, or deleted; who created, modified, or deleted the data; when a copy of the data was made; who made a copy of the data; security and access information; data privacy; and under SOX compliance.

18. The method of claim 16, wherein the encoded data is decoded to reveal the traits of the data.

19. The method of claim 16, wherein the encoded data is tamper detectable.

20. The method of claim 16, wherein the traits are encoded in the bit plane of the data.

21. The method of claim 16, wherein the certificate value is also encoded in the bit plane of the data.
